(19) United States
(12) Patent Application Publication
(10) Pub. No.: US 2003/0043495 A1
(43) Pub. Date: Mar. 6, 2003

(54) Massively parallel fixed head disk drive

(76) Inventor: David F. Mayer, Columbus, OH (US)

Correspondence Address: David A Greenlee, PO Box 340557, Columbus, OH, 43234-0557, US

(21) Appl. No.: 10/069,672

(22) PCT Filed: Jun. 22, 2001
(86) PCT No.: PCT/US01/19944

(51) Int. Cl. G11B 21/02

(52) U.S. Cl. 360/75

(57) ABSTRACT

The invention provides an extremely high throughput magnetic disk drive which uses massively parallel architecture to achieve unprecedented sequential and random access transfer rates. The drive consists of a stationary magnetic head assembly comprising a single integrated circuit made of silicon along with the associated disk and controller. This intergrated circuit contains heads, amplifiers, buffers and circuits for verification of all disk operations. The head assembly operates on disks made of crystalline silicon to avoid problems of differential thermal contraction and to insure rigidity. It communicates with the host computer's random access memory by means of a novel and unique disk controlled, which has the high capacity throughput to take advantage of the high throughput speed of this disk drive. The most important feature of this disk drive is that all disk tracks are processed (read or written) concurrently each time a given sector is available to the heads, which means that the entire disk can be read or written on each revolution. Massively parallel architecture throughout the head and controller design permits the achievement of typical sequential input/output transfer rates of more than 60 Gigabytes per second, having average sequential access times of 0.011 microseconds (roughly 2000 times as fast as current technology) and average random access times on the order of 10 microseconds (roughly 5000 times as fast as current technology). This will provide large multi-user computer systems with an overall increase of throughput of a factor of at least 2000.

### CROSS REFERENCE TO RELATED APPLICATIONS

This application claims priority of U.S. Provisional Application Serial No. 60/213336, filed Jun. 22, 2000.

### BACKGROUND OF THE INVENTION

1. Technical Field

This invention relates to computers, and, more particularly, to an ultra-high speed data storage for computers.

2. Background Art

Computer technology today has a major bottleneck caused by the slowness of bulk storage. Although integrated circuits are used for main random access memory (RAM), they are too costly to be used for bulk storage. Instead, almost all online bulk storage is performed by magnetic disks, with the remainder on optical disks, magnetic tape or optical tape. The difference in speed between magnetic disks and RAM is approximately a factor of one million. Therefore, since computers are limited by the speed of the slowest component, the computer seldom can run at its maximum capacity. Large, multi-user systems often take several seconds to perform an indexed query when hundreds or thousands of users are running programs concurrently. Large full table scan queries (i.e. reading of a complete data table) often take many minutes, and sometimes hours or even days. Thus, the present state of the art of bulk storage does not permit the computer to achieve its true potential.

This slowness of the current disk technology is due to two types of delay which are inherent in the way disks are designed: seek delay and latency delay. Seek delay is the time required for the movable head to reach the requested track. Latency delay is the time required for the requested data to rotate to a position under the head so that it can be processed. A track is the data written along a circle about the center of the disk, white a sector is the data written along a radius of the disk.

There are typically two different modes of access to data on bulk storage devices: random and sequential. Random access refers to the reading or writing of disk data in an arbitrary order. Sequential access refers to the reading of writing of disk data in order of increasing block number. On large multi-user systems, the competition (called ‘contention’ in the art) for the same disk to access various data blocks by the numerous users frequently causes very large delays in random access time. Furthermore, the increasing use of very large relational data sets has increased the need for rapid sequential access to perform full table scans. The need for faster bulk storage is critical for the effective operation of the latest sophisticated relational database management software.

### BRIEF SUMMARY OF THE INVENTION

It is an object of this invention to provide a device that eliminates the performance bottleneck by increasing both random and sequential storage access speeds by a factor of at least 2000 for large multi-user computer systems.

It is another object of this invention to eliminate the seek delay entirely, and to collapse or overlap all latency delays for pending requests into a single latency delay.

This invention accomplishes a vast reduction in delays, which permits concurrent random and sequential access by thousands simultaneous users in average times of microseconds instead of milliseconds, seconds or minutes. This reduces each user's elapsed time to that required for no more than a single disk revolution, provided that the data on the disk is properly organized. This reduction in time is achieved by the use of Massively Parallel Architecture throughout the design of the disk drive of this invention. Instead of reading or writing one or only a few tracks simultaneously, this invention operates on all disk tracks concurrently (in parallel), which is enabled by the use of a novel head assembly, controller and magnetic disk.

In one aspect, this invention features a magnetic head assembly, with associated electronics comprising read and write buffers, amplifiers, encoders and decoders, mounted on a single silicon wafer, which permits all tracks to be either read or written concurrently. Thus, each time a sector passes the magnetic head assembly, every track on the sector is read or written. This capacity is made possible by the Massively Parallel Architecture of the invention. This far surpasses the performance of any magnetic disk of the current technology. The magnetic head assembly also contains proximity sensors, which permit much more precise positioning and alignment of the assembly relative to its respective disk than can be achieved with current technology.

Another aspect of this invention features a disk controller that has Massively Parallel Architecture to match that of the magnetic head assembly. This controller permits data transfer requests from the computer to be sorted and processed on the fastest possible basis. It consists of two interdependent modules: the operation sequence module and the data transfer module. After a request has been completed, the operation sequence module informs the computer of this by means of a priority interruption. Concurrently, with the queuing and post-processing of individual requests, the data transfer module transfers data between the magnetic head assembly and the main memory bus of the host computer. The magnetic disk of this invention can move data read from, or write to, thousands of tracks simultaneously.

In a further aspect, this invention features a magnetic disk rotor designed to facilitate the high tolerances and stability, which the magnetic head assembly requires in order to function. The magnetic disk rotor comprises a shaft which mounts the magnetic disks, electric motor and magnetic bearings. Each magnetic disk is made of a slice from a perfect crystal of silicon. The entire rotor is suspended in air (or other gas) by magnetic bearings, which provide vibration-free operation, or alternately, in vacuuo. Each silicon disk is coated with an amorphous, high-coercivity film composed of rare-earth elements and cobalt.

These and other objects and features of this invention will become more readily apparent upon reference to the following detailed description of a preferred embodiment, which references the attached drawings, in which:

### BRIEF DESCRIPTION OF THE DRAWINGS

FIGS. 1a, 1b and 1c are schematic front, bottom and side views of the magnetic head assembly mounted on a silicon wafer according to this invention;

FIG. 2 is a schematic view of one row of heads mounted on the silicon wafer of FIGS. 1a, 1b and 1c;

FIG. 3 is a schematic view showing the physical orientation of the magnetic head assembly to the disk;

FIGS. 4a and 4b are schematic bottom and front views of the head assembly mounting arrangement of this invention;

FIG. 5 is an enlarged schematic view of the head assembly of FIGS. 4a and 4b;

FIG. 6 is a physical design schematic view of the head assembly of FIGS. 4a and 4b;

FIG. 7 is a schematic view of a single row of head electronics, shown rotated 90° relative to FIG. 6;

FIG. 8 is a schematic view of the data transfer module of the disk controller of FIG. 7 mounted on multiple wafers;

FIG. 9 is controller detail schematic view of the operation sequence module of the disk controller of FIG. 7 mounted on multiple wafers;

FIG. 10 a schematic view of the disk rotor assembly, with the head assemblies removed for clarity;

FIG. 11 is a schematic view of the permanent magnet array for the magnetic bearings and motor;

FIGS. 12a and 12b are schematic views of the inductively reactive array for the magnetic bearings;

FIG. 13 is a schematic view, illustrating the operating principles of the magnetic bearing;

FIG. 14 is a schematic view of a zoned disk;

FIG. 15 is a schematic view of an optical disk of an alternative embodiment of this invention; and

FIG. 16 is a view similar to FIG. 3, but illustrating an optical head.

### DETAILED DESCRIPTION OF A PREFERRED EMBODIMENT

Magnetic Head Assembly

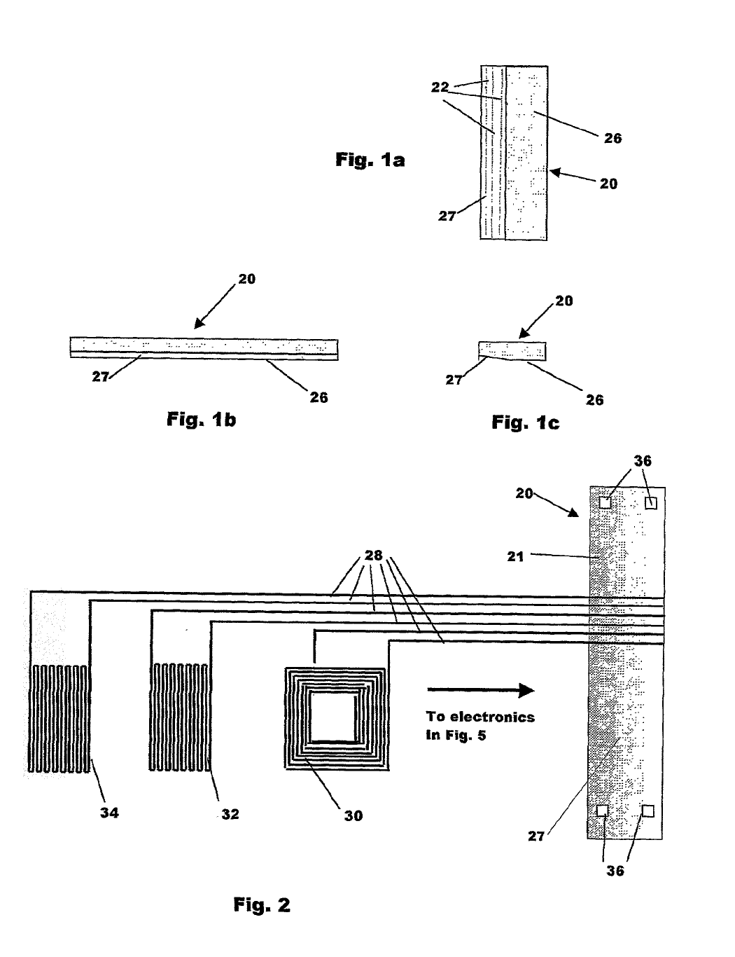

Referring to FIGS. 1a, 1b, 1c, 2 and 3 of the drawings, an integrated circuit magnetic head assembly 20 consists of a single silicon wafer 21 which mounts a very large number of magnetic head sets 22 (read, write, verify—illustrated as dashed lines in FIG. 1b), one for each track of the magnetic disk along with the associated read, write and verify electronics. The number of headsets can vary from about 10,000 up, although 32,758 is used here as an example. Wafer 21 is shaped as a beveled parallelepiped, the length of which is determined by the size of disk 24 on which it is associated. Magnetic head sets 22, mounted on the silicon wafer's 15° bevel surface 27, and other integrated circuits mounted on wafer bottom 26 are connected by conductors 28, which go over the obtuse edge of the bevel 27. The circuits mounted on wafer bottom 26 are later detailed in reference to FIGS. 5-7.

There are three rows of magnetic heads mounted on bevel 27: write heads 30, read heads 32 and verify heads 34. These rows of heads are not parallel, but are on line segments determined by the radius of the circle of the magnetic disk. Thus, those heads at greater distances from the center will be further apart from each other than those closer to the center. The distance between the rows is visually indistinguishable, but has been greatly exaggerated in the drawings for illustration.

Write heads 30 are thin film magnetic loops deposited on the silicon using standard photolithographic technology. The detailed structure of the loops involves superposition of several loops in each annulus about the center of the head, as shown in FIG. 2. Read heads 32 and verify heads 34 are magneto-resistive in nature. The Magnetic head assembly is fixed. It does not move during operation, as do most other magnetic disk systems.

Magnetic Head Assembly Mounting

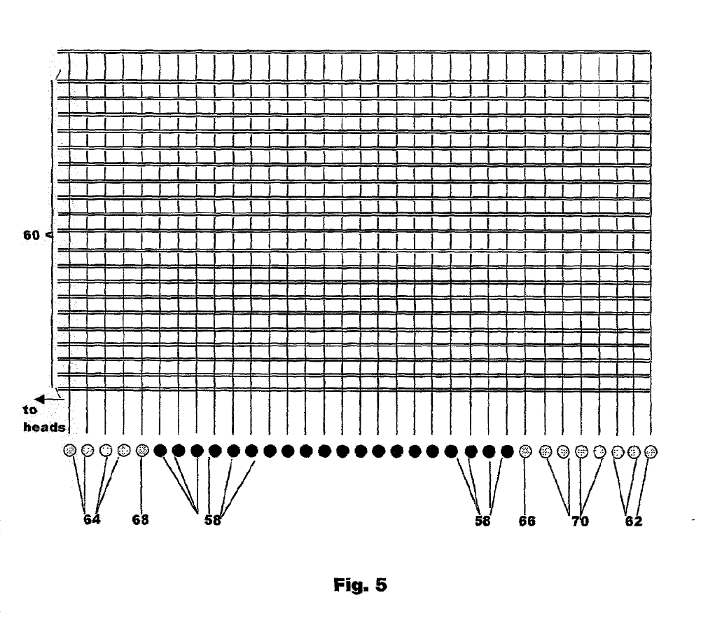

As shown in FIGS. 4a and 4b, Magnetic head assembly 20 is encapsulated in a rigid plastic package 40, which connects external contacts to the contact points on the head assembly. The side opposite the electronic circuits is attached directly, via vacuum contact bonding, to a heat sink in the form of a thin plate of soft aluminum 42 that has fins which create an air gap 44 for heat dissipation. Aluminum plate 42 is not covered, but is exposed to permit the dissipation of heat into the surrounding atmosphere of air or other gas. If a vacuum is used, then the head assembly must be connected to a coolant source and drain by means of flexible tubing. The integrated circuit package is then mounted on a non-magnetic steel platform 46 by piezoelectric adjustable mounting pads 48, which provide true three-axis rotation and three directional motion of small magnitude. Platform 46 is mounted on an axle 50 by a multiple-hinge joint 52 that is rigidly mounted on the disk drive chassis 54 by vernier screws 56, which are adjustable to align the axle permanently. After alignment, vernier screws 56 are locked into place.

Integrated Circuit

The components of the integrated circuit are logically, but not physically, arranged in rows and columns. Each row corresponds to a single disk track, while each column corresponds to a single block of data to be read from or written to a track. A disk block is the number of bits that are read or written as a single unit. The totality of columns corresponds to a single disk block. A typical arrangement of tracks is shown in Table 1. The numbers shown are exemplary only. Unlimited numeric combinations are possible.

TABLE 1

| blocks/ | bits/ | tracks/ | total bits | bits/ | bits/ | sides/ | bits/ |
|---|---|---|---|---|---|---|---|
| track | track | side | on head | side | block | drive | drive |
| 4,096 | 2,097,152 | 32,768 | 50,331,648 | 68,719,476,736 | 512 | 6 | 412,316,860,416 |
| | bytes/ | | bytes | bytes/ | bytes/ | bytes/ | |
| | track | | on head | side | block | drive | |
| 2,097,152 | 262,144 | 32,768 | 6,291,456 | 8,589,934,592 | 64 | 6 | 51,539,607,552 |

Number of tracks = 32,768 = 2¹⁵
Three disks, each with two sides = 6 sides per drive
Disk diameter = 128 mm, excluding 5 mm outer margin
Width of recording surface = 32 mm (from inside track to outside track, inclusive).
Track spacing = 32/32,768 mm = 0.9765625 μm = approximately 1 micrometer (μm), well within current practice
Length of smallest track = 2 * π *32 mm = 201.06 mm
Bits per millimeter = 2,097,152 (bits/track)/201.06 (mm/track) = 10430.478 (bits per mm, not including redundancy)

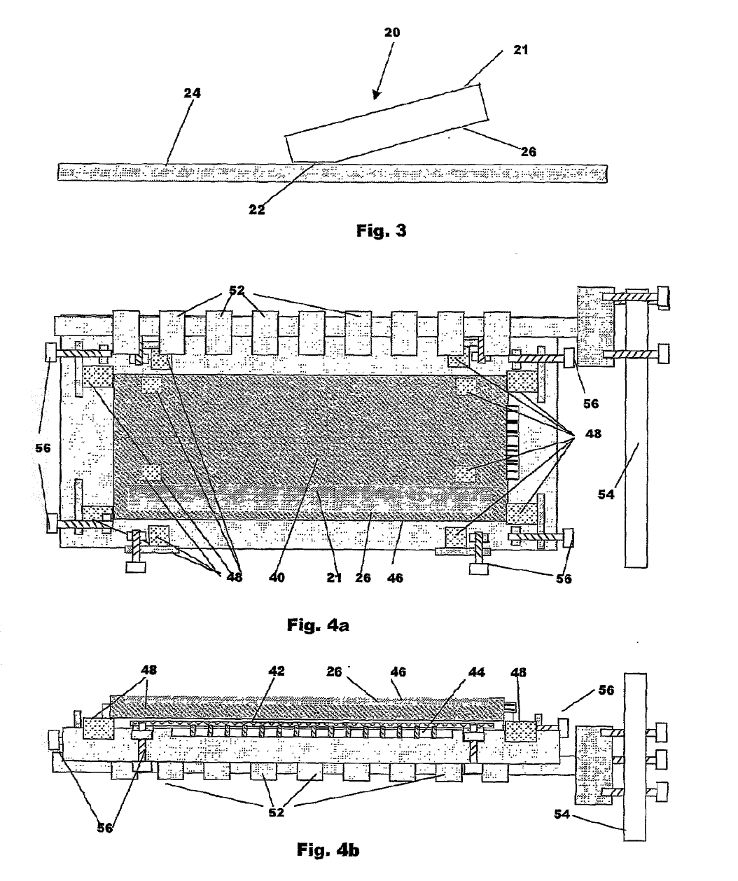

There are several types of functional components in the integrated circuit: conductors, gates, amplifiers and pulse generators. FIG. 2 shows a highly simplified and schematic representation of one head bevel sub-assembly of write 30, read 32 and verify 34 heads. FIG. 3 shows the physical orientation of magnetic head assembly 20 relative to the disk.

The recording density, in bits per linear millimeter of track, and tracks per millimeter or radial distance are well within current industry standards. However, because of the combination of extremely precise positioning, small head size and small magnetic domain size, it should be possible to increase both the number of tracks and the number of sectors, resulting in a very large increase in disk capacity. In fact, both the number of tracks and the number of sectors can be at least doubled (relative to current technology), giving at (east a fourfold increase in disk capacity, in addition to much faster access.

Head Assembly Electronics Array

Each track of the disk is served by a row of elements on the head assembly. Each of the exemplary 32,768 rows represents an entire block (typically 512) of single-bit registers, plus additional (typically 64) redundant error detection and correction registers. Each row is actually a triplet of rows: write, active, and read, as explained below. A detailed schematic of head assembly detail is shown in FIG. 5, where each column 58 (typically numbering 512+64 columns) represents a single bit input/output conductor. There are also other lines 60 (typically numbering 36) representing the row address (track) of the row being processed, a read/write command line, (typically numbering 16) frequency standard lines, and error control lines. Due to limitations inherent in describing microscopic components, only a small fraction of the rows and columns are shown. Columns for the electric power supply are designated 62. The row of circles 64 at the bottom of FIG. 5 represents contact points for connection via case conductors to a disk controller.

This design involves Massively Parallel Architecture in that all tracks are read or written simultaneously. Thus there are many (typically numbering 32,768) input or output operations that occur concurrently. Reference frequency lines carry the read/write frequency standards from the disk controller to the modulators and detectors located in the rows. Data and redundancy lines conduct the data and redundancy information to and from the disk controller. Only a few of the data lines are illustrated.

Control lines 66 carry the command (read, write, format, etc) from the controller. Only one control line 66 is shown. Error lines 68 carry error events to the controller. Address lines 70 carry the active row address from the controller to the rows, causing exactly one row to respond to each command from the controller while the other rows ignore the command. Power lines 62 carry electric power (+ positive, − negative, G ground) from the power supply to the components on the head assembly.

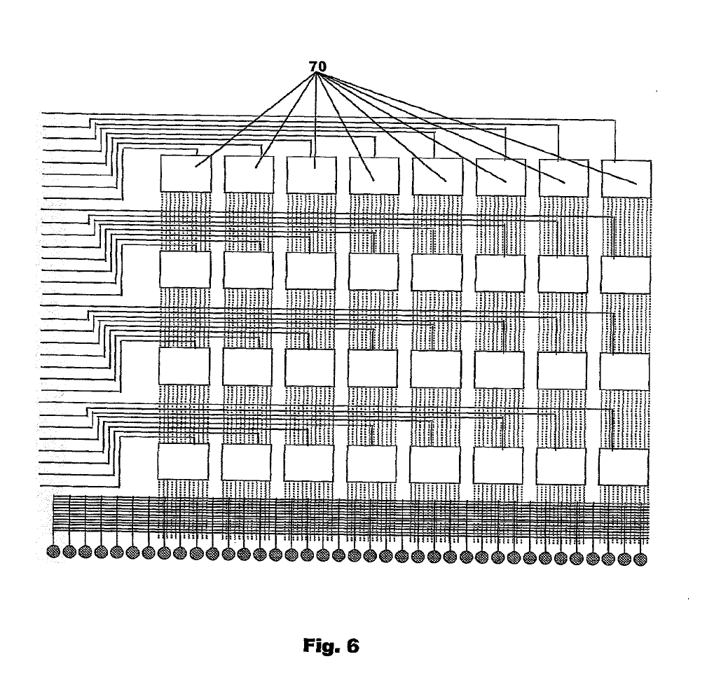

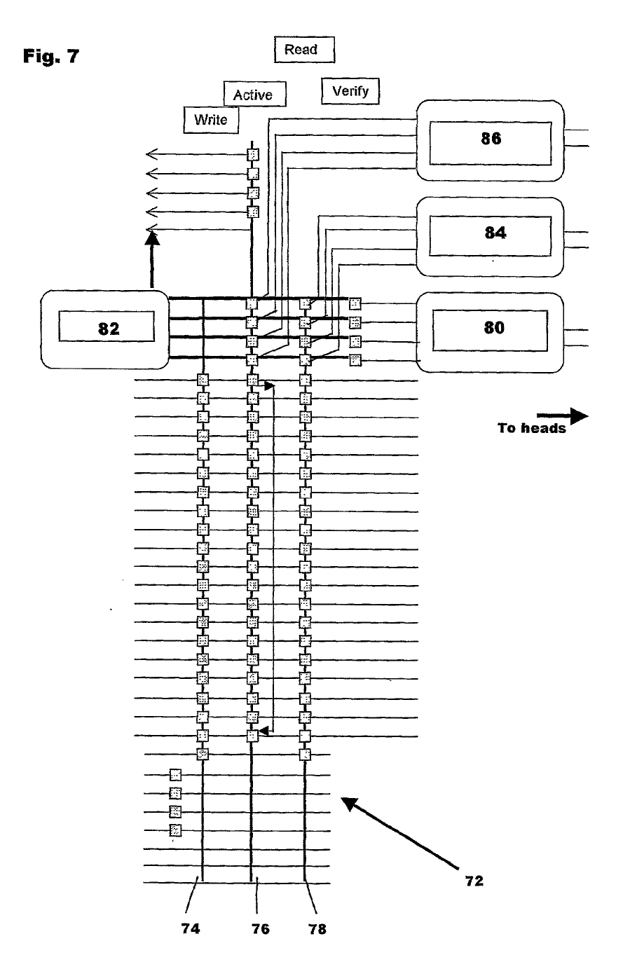

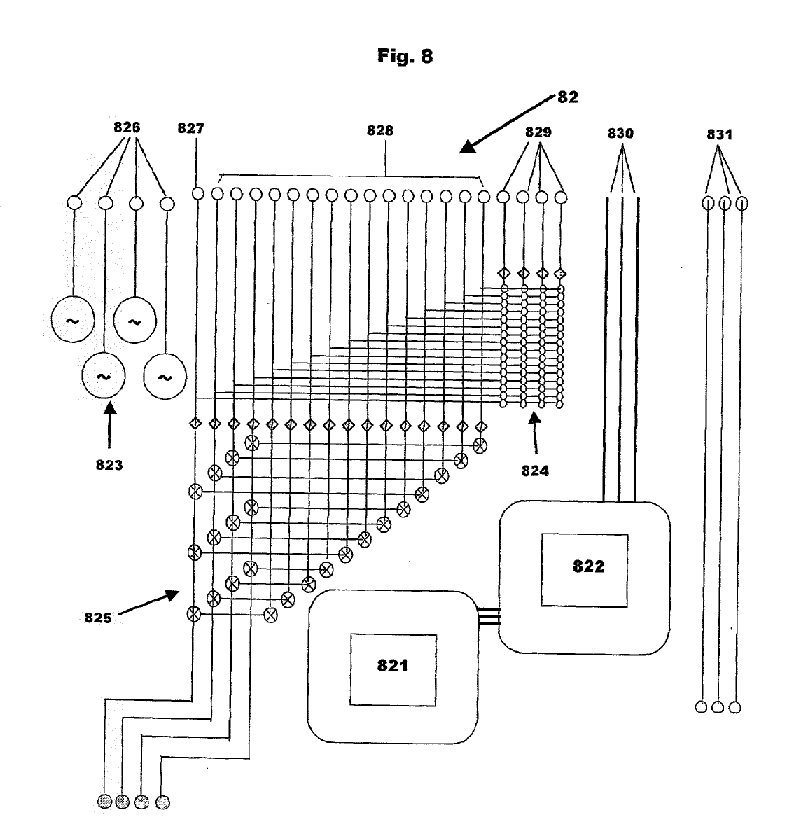

The actual physical layout of magnetic head assembly 20 differs from that shown in FIG. 5 because of the need to make the component density roughly the same in both directions. The physical layout is illustrated in FIG. 6. Only a small number (32) of the line electronic units 70 are illustrated. Each of the small boxes represents the electronic unit that supports a single row or disk track. They are staggered so that the number of circuit elements is roughly the same both horizontally and vertically. The horizontal lines at the bottom represent the crossbars that take the input, output, control, and power lines to all modules. This electronic unit is further shown in FIG. 7.

Magnetic head assembly 20 reads and writes information in discrete data packets, each 16 to 64 bits in length, using Analog Coded Binary modulation. Each data packet is converted into an analog signal, which either contains or does not contain each of the reference frequencies, according to whether the associated bit is either 1 or 0. This method of encoding is widely used in modems where its inherent qualities permit both high bit transfer rates and low error rates. As shown in FIG. 7, each functional row consists of the following components:

1. Conductors 74, 76, 78 to heads on bevel surface.

2. A verify amplifier/demodulator 80 which translates recorded Analog Coded Binary information from verify head back into true binary form.

3. Verify comparison buffers 82 to compare data just read from the verify head with data read on the previous read cycle or written on the previous write cycle. If these buffers do not agree, an error is generated and sent down the error line to the controller.

4. A read amplifier/demodulator 84 that translates recorded Analog Coded Binary information from read head back into true binary form.

5. A write modulator/amplifier 86 that combines the input bits into an Analog Coded Binary signal by using each bit (typically 16 to 64) to control the presence or absence of each associated reference frequency in a data packet.

6. Three data sub-rows: write, active, read; each consisting of (typically 512+64) 1-bit registers. The active row is equipped with circular shifters to permit data in each row to be shifted down (as shown by arrow) 16 to 64 bits at a time to move the data into and out of the read/write section of the active row.

7. Gates permitting data from the data lines to flow into the input sub-row and data from the output sub-row to flow into the data lines.

8. Shifters which cause data to move from the write sub-row into the active sub-row on a write operation or moving data from the active sub-row into the read row on a read operation.

9. An Address Detector which causes one and only one row to respond to each command from the disk controller.

As an alternative to the use of Analog Coded Binary recording, discrete individual bits can be written and read, as is commonly done with current technology. However, Analog Coded Binary recording offers higher data densities, an increased signal to noise ratio and lower sensitivity to surface defects.

Disk Controller

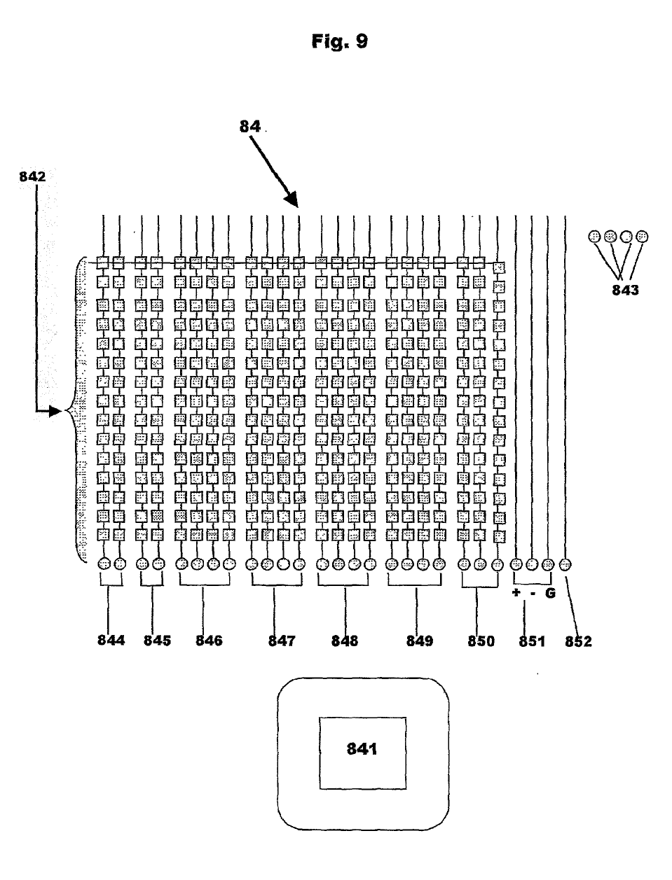

To utilize the extremely high transfer rates contemplated (in excess of 60 Gigabytes per second), a novel disk controller is required, since standard controller architecture cannot handle the transfer rate of the disk drive. Therefore, a new type of controller that uses Massively Parallel Architecture to speed processing was devised. Disk controller 81 comprises two functional modules, a data transfer module 82 (FIG. 8) and an operation sequence module 84 (FIG. 9). In FIG. 7, disk controller 81 is shown schematically with both modules 82 and 84 mounted on a single silicon wafer, merely to illustrate the relationships between the components. In practice, the each of the controller modules 82 and 84 will comprise several integrated circuits mounted on a circuit board. In particular, the control processors are simple, special-purpose, customized, 32 or 64 bit microprocessors with programmable read only memory (PROM) as well as dynamic random access memory (DRAM). These processors generate the control signals which cause the other components of magnetic head assembly 20, data transfer module 82 and operation sequence module 84 to carry out their functions in the proper order and with the proper timing.

Operation sequence module 82 keeps a list of pending operations and transfers them, one at a time, to data transfer module 84. This list is kept in sector order, and in FIFO (first-in-first-out) order within a given sector. The entries for the current sector are always maintained at the top of the list.

Data transfer module 84 receives commands from operation sequence module 82, which it executes one at a time. Each command causes data to be transferred either from main memory to the head assembly (write) or from the head assembly to main memory (read). Data transfer module 82 has three separate connections to other devices to:

1. transfer data to and from the head assembly 20.

2. receive commands from the operation sequence module 84 and transfer control information back to itself.

3. send data to, and receive data from, the host computer via a direct access memory port.

These two modules operate asynchronously relative to one another, with periodic synchronization and coordination performed by testing of the done flag of data transfer module 82 by operation sequence module 84.

Disk Operating Cycles and Control Functions

Although head assembly 20 and controller 81 operate together, the operating cycles will be outlined separately for clarity. Since control flows from operation sequence module 84 through data transfer module 82 to head assembly 20, these components will be described in this order.

Operation sequence module 84 comprises an operation sequence control processor 841, a command list array 842, current sector contacts 843, and priority lines 844, request lines 845, memory address lines 846, block count lines 847, track number lines 848, sector number lines 849, control lines 850, power lines 851 and a busy line 852. Operation sequence module 84 performs strategic control of all operations of the entire disk drive. It receives commands from the host computer (not shown) via the disk driver program, sorts these commands in order of disk sector, and passes the topmost command to data transfer module 82 for further processing. When data transfer module 82 has completed its operation, operation sequence module 84 then informs the host computer of the completion via a call to the priority interrupt system. The information designating which operation was completed is given in the request register. This designation number is not processed by the controller, but it is returned to the host computer when a request is completed so that the disk driver program running on the host computer knows which request was just completed.

The command list array contains the list of pending commands. This list is updated dynamically to make best use of the high throughput speed and minimize unneeded seeks. It has the ability to shift its contents up or down, either from top to bottom, or from a certain specified insertion point on downward. The list is sorted incrementally by means of a massively parallel sorting algorithm developed especially for this controller. The controlling algorithm (described below), as implemented in the circuit design, permits an ultra high speed insertion-type sort to occur at speeds that are orders of magnitude faster than the speed of conventional insertion-type sort operations. Operation sequence module 84 functions as follows:

Operation of the Operation Sequence Module

The disk driver program tests the busy flag of the controller and, if it is clear, sets it along with the other bits in the register of the controller with the command to be executed. If the disk driver finds that the busy flag is already set, it must wait until the flag has been cleared by the controller. If all of the rows in the array are in use, the busy flag is set until the bottom row is shifted up. This prevents the overflow of commands. If the busy flag is not set by the disk driver, no action occurs.

A command is deposited in the command register by the host computer during execution of the disk driver routine with command mode 0=data. If the command is a “read”, the sector field is incremented by 1. If the command is a “write”, the sector field is decremented by 1. In no case is the sector field left unchanged. The purpose of this action is to cause data which is to be written to be moved to the write buffer before the sector becomes active, and data which is to be read to be moved from the read buffer after the sector has become active and the read operation has been completed.

The sector field of the command is transferred into the comparison registers of all of the rows in the command list array. Then it is subtracted from the sector field of each row. If the difference, modulo 4096 (or whatever the dimension of the command array happens to be) is less than the row number, the shift flag is set for the row. This achieves massively parallel comparison of the data to be inserted with the data already in the rows prior to insertion. All rows having their respective shift flags set are shifted down one unit. This achieves massively parallel movement of the list.

The first row that was shifted down has its active flag set. This is the exclusive OR that the shift flags above and below the row in question. It will be set for exactly one row. The top row is always considered to be preceded by a non-shifted row, and the bottom row is always considered to be followed by a shifted row for this purpose.

The “transfer in progress flag” of data transfer module 82 is then tested. If it is clear, then the transfer register of data transfer module 82 replaces the top row of the Operation sequence stack, while all other rows are shifted down 1 unit. If the block count is zero, then this row is transmitted to the “completed” register of the operation sequence module 84. Otherwise, the sector address register is incremented by 1 modulo the number of sectors, which places this operation at the top of the next sector to be processed. All rows pertaining to the current sector are shifted to the bottom of the operation sequence stack. This will permit them to be done the next time this sector is current. Simultaneously, the first row pertaining to the next sector comes to the top. Then the current sector register is incremented by 1 modulo the number of sectors.

The top row of the operation sequence stack is shifted into the transfer register of the Data transfer module along with the new current sector, and the “transfer in progress” flag is set. The cycle then restarts from the top.

Operation of the Data Transfer Module

Data transfer module 82 is shown in FIG. 8 and comprises a data transfer control processor 821, a head assembly control processor 822, reference oscillators 823, a redundancy generator 824, word shifters 825, reference frequency lines 826, error lines 827, data and redundancy lines 828, control lines 829, sector number lines 830 and power lines 831.

Data transfer module 82 operates concurrently with, and independently of, operation sequence module 84. However, their operations are coordinated by a flag on data transfer module 82 called “transfer in progress flag”. The block count register is tested. If it is zero, the operation is complete and the transfer flag is cleared. The sector number is tested against the current sector. If they are not equal, the transfer is complete as far as the current sector is concerned. However, since the block count is not zero (otherwise, the previous case would have occurred), the remainder of the transfer is rolled over to the next sector by operation sequence module 84. The cycle continues as above until one of four conditions occurs:

1. An error.

2. The block count becomes zero, which is the only case that signifies proper completion of the request.

3. The specified sector is no longer current because the disk has passed it by, which requires another revolution. This occurs when there has been insufficient time to process all requests that pertain to a particular sector. This is not an error, but permits the request to be continued at a later time.

4. The track number rolls over to zero, which causes the request to be rolled down to the next sector, where more sequential blocks are processed. This is not an error.

Head assembly 20 does not have an internal processor, but relies entirely on data transfer control processor 85 (FIG. 8) of disk controller 81 for direction. It connects only with data transfer module 82 of disk controller 81 on one side and the disk itself on the other side, via the magnetic heads and the proximity sensors.

Every track is either read or written each time that it passes under the heads. First, the controller tests the current sector address. If it equals to the sector to be read, processing of this sector proceeds. Otherwise, processing of this sector must wait until another revolution of the disk has made the sector current again. Data transfer module 82 then informs operation sequence module 84 that the transfer either is deferred or is complete.

In the read cycle, the controller places the sector number into the sector address register. The row which was addressed transfers the contents of its read sub-row into the data transfer lines, and this data is loaded into the data register, while setting the control line to 0=Read. Since the address used is (the sector to be read+1) modulo number of sectors, the read transfer takes place after the sector has been physically read.

In the write cycle, the controller places a block of data into the data register and places the sector number into the sector address register, while setting the control line to 1=Write. Since the address used is (the sector to be read−1) modulo (number of sectors), the write transfer takes place before the sector has been physically written.

Magnetic Head Assembly

The proper positioning of magnetic head assembly 20 is critical for correct operation. Unlike current technology, in which heads are floated on air, magnetic head assembly 20 has its position adjusted by piezoelectric adjusters 48 which are controlled by disk proximity sensors located near the four corners of the bevel surface. These conductive plates are connected to oscillator circuits and are used as capacitors. As the separation between the plates and the disk surface changes, so does the capacitance of the associated sensor element. This causes the frequencies of the four proximity detection oscillators to change, which in turn gives the controller the information that it needs to adjust the piezoelectric position actuators.

In addition to the data tracks, two alignment tracks (the innermost and outmost tracks on the disk) are written during formatting. Each track contains a repetition of its sector number in each packet. These tracks are then read continuously, and the sector number is compared with the sector number in the sector address register. Any difference causes an error to be reported to the controller, and thence to the host computer. Differences in phase between the alignment tracks are used to adjust the piezoelectric alignment actuators which keep magnetic head assembly 20 properly aligned at all times.

Disk Rotor Assembly

The precise tolerances of magnetic head assembly 20 require equally precise tolerances in disk 24. If the coefficients of thermal expansion of disk 24 and head assembly 20 are not identical, track alignment will be impossible as temperature changes. This requires either extremely accurate temperature control of the disk drive, or construction of the disk and head assembly of materials having identical coefficients of thermal expansion. This track alignment problem is best solved by having a disk made of the same material as the head assembly, preferably crystalline silicon. A crystal of pure silicon is both very strong and very rigid. These mechanical properties are perfect for use as a disk substrate.

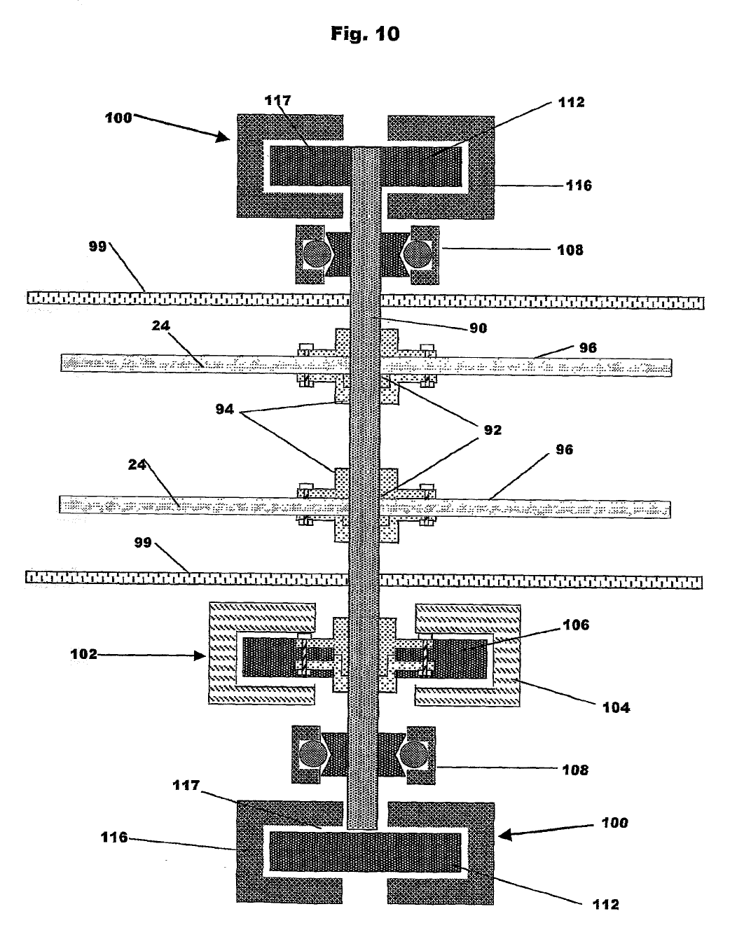

In the production of semiconductor chips, large boules of crystalline silicon are produced. These boules are sufficiently large to be used as substrates for magnetic disks. The process of production involves sawing the silicon into slices of uniform thickness with a diamond saw, as is usually done for circuit manufacture. Next, the slice is polished to an average deviation from flatness of less than 40 nanometers. The smoother the surface, the closer the heads can be to the disk, and therefore, the greater the recording density. (By comparison, telescope mirrors are ground with a maximum error of typically less than 4 nanometers.) Then a hole is drilled into the approximate center of the slice. Finally, the slice is further machined into a perfectly round shape and finished on a lathe with diamond abrasive to produce a precisely circular shaped disk 24. A toot steel spindle or axle 90 is inserted through the hole 92 and secured by clamps 94, as shown in FIG. 10. The entire structure is then balanced on a lathe to eliminate vibration. This process results in a precisely flat disk 24 of crystalline silicon secured exactly perpendicularly to axle 90 by clamps 94. This results in a perfectly balanced disk rotor assembly 98, shown comprising two disks 24 in FIG. 10.

Next, an amorphous metallic thin film of a rare-earth element and cobalt 96 is deposited from a vacuum onto both sides of the disk. This film has a thickness of approximately 100 to 200 nanometers, and forms the magnetic memory surface of the disk. The use of amorphous material, instead of crystalline material, enables use of much smaller magnetic domains than would otherwise be possible, thus allowing higher densities, as well as providing a highly linear recording medium. In an amorphous magnetic metal film, there are extremely tiny magnetic domains randomly oriented relative to each other, as quasi-crystalline nanostructures. These are much smaller than any magnetic particles that are currently in use for magnetic recording.

Disk rotor assembly 98, comprising two disks 24 mounted as an array on spindle 90, and shielded by soft iron magnetic shield plates 99, is suspended by magnetic induction bearings 100 to minimize vibration and friction. The high strength and extreme rigidity of silicon make each disk 24 both dimensionally stable and durable at very high rotation speeds. Disk rotor assembly 98 can be operated at a minimum of 100-200 revolutions per second (6,000- 12,000 rpm), and possibly as fast as 1000 revolutions per second, producing an average latency time of 5 to 0.5 milliseconds (10 or 1 milliseconds/2). The spindle is spun by a DC motor that is electronically controlled to maintain speed within 0.01% of the specified speed.

During initial rotation at startup, ball bearings 108 support disk rotor assembly 98. As speed increases, magnetic induction bearings 100 begin to function to lift and float the spindle, so that ball bearings 108 disengage from their contact spool. Consequently, magnetic bearings 100 alone support the entire disk rotor assembly 98 during operation. These bearings provide a zero-vibration environment for the interaction between disks 24 and head assemblies 20 (not illustrated in FIG. 10; see FIGS. 1a, 1b, 1c and 3). Magnetic bearings 100 provide a high level of damping as well as support. The absence of head motion also permits the entire system to be free of the vibration inherent in conventional drives, which is caused by the movement of a magnetic head that effects movement of the entire disk chassis in the opposite direction. Absence of vibration eliminates any vibration-induced track alignment problems.

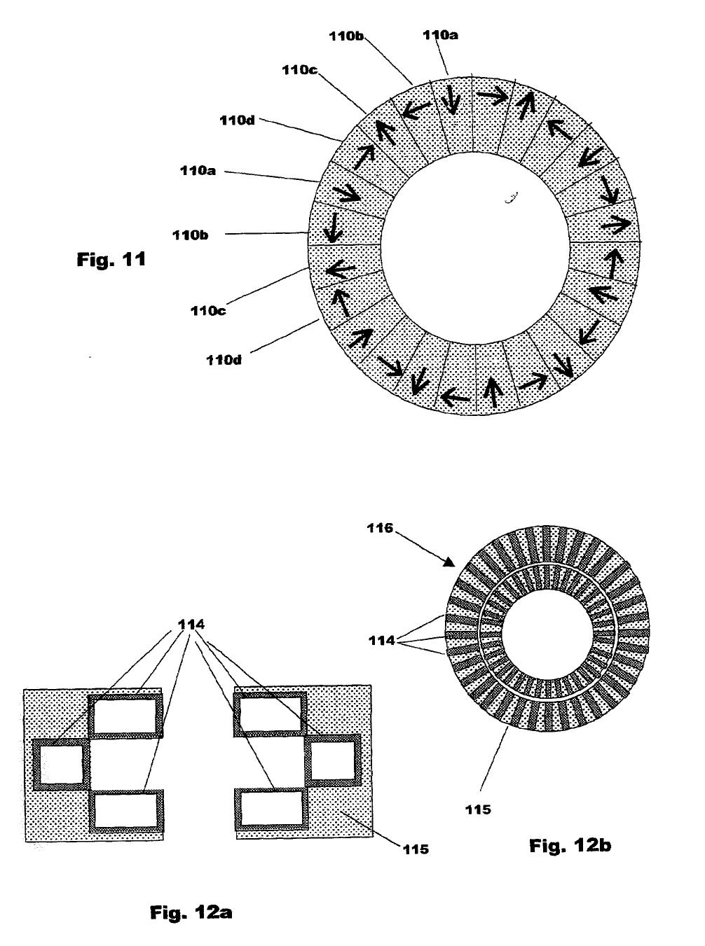

Referring to FIGS. 11, 12a and 12b, magnetic bearings 100 that operate on an induction principle. A plurality of permanent magnets 110, comprising alternating sets of four alternating magnets 110a, 110b, 110c and 110d in a circumferential array, each set comprising four different magnets arranged, sequentially counterclockwise, with north poles respectively pointed inward (110a), counterclockwise (110b), outward (110c) and clockwise (110d), as shown in FIG. 11. This arrangement of poles causes the magnetic fields to reinforce each other on the outside of the rotor, while canceling each other on the inside of the rotor.

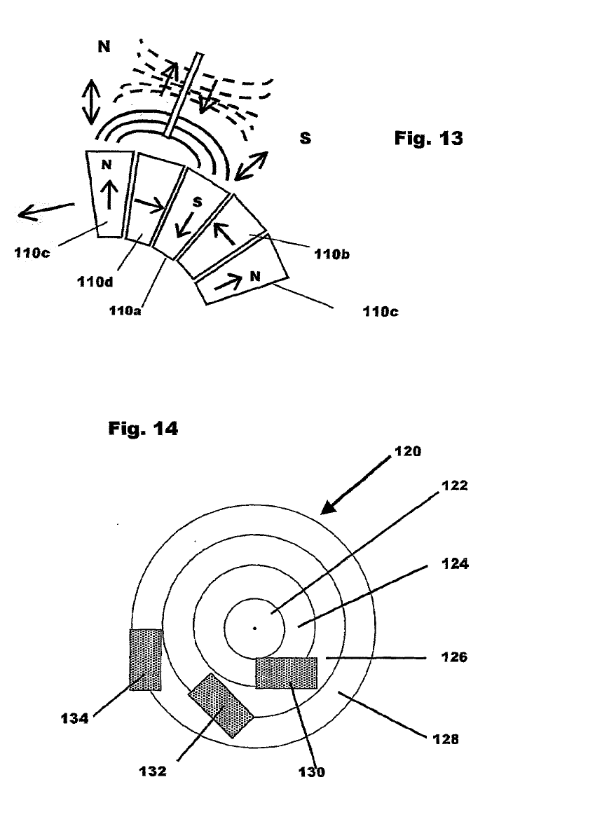

Stator 116 comprises three sets of reactance loops 114a, 114b and 114c embedded in a nonmetallic support 115, which surrounds rotor 112, as shown in FIG. 12. These reactance loops are preferably aluminum, although other highly conductive materials, such as copper, silver and gold, could be used. As rotor 112 spins, the north and south magnetic poles of magnets 110a, 110b, 110c and 110d alternately pass by each of the aluminum reactance loops 114a, 114b and 114c on stator 116. This induces a current in each loop that produces a magnetic field 118 which is necessarily oriented in the same direction as that of the inducing field. This causes magnets 110 and the aluminum loops 114 to repel each other to center rotor 112 within stator 116 and provide an air gap 117 to substantially frictionlessly (excepting surrounding gas friction) “float” rotor 112. The configuration at the time when the loops are exactly between the nearest north and south magnetic poles is the time of maximum induced current, and hence maximum induced magnetic field, as shown diagrammatically in FIG. 13. Only a single loop is shown for illustrative purposes. Of course, the composition of stator 116 and rotor 112 could be reversed, with rotor 112 mounting reactance loops 114, and stator 116 mounting magnets 110.

The driving motor is conventional, with the exception of the use of the Halbach magnetic arrays which are arranged exactly like the magnetic bearing rotor described above. Drive coils alternately attract and repel the magnetic poles of the motor magnetic array. These are managed by the disk controller to synchronize the motor with the operation of magnetic head assembly 20.

Disk Rotor Manufacturing Process

The process of manufacturing crystalline silicon disk rotor assembly 98 comprises the steps of:

1. Cutting a disk from a standard boule of crystalline silicon such as used in the manufacture of integrated circuits,

2. Rounding the disk to a perfect circle with a tolerance of 1 micrometer,

3. Polishing the disk to a tolerance of 40 nanometers or less,

4. Drilling all necessary holes for the spindle and the mounting screws,

5. Marking a location near the one of the mounting screw holes by a scratch with a diamond stylus,

6. Dynamically balancing the mounting brackets,

7. Mounting the disk on a test spindle with the marked and balanced brackets attached by mounting screws. The mounting screws all have the same weight within a 1 microgram tolerance, and are labeled with numbers by scratches,

8. Marking the mounting brackets with a diamond stylus to identify the orientation relative to the scratch on the disk, thus insuring that each disk will be mated with the same bracket pair in the same orientation,

9. Dynamically balancing the mounted disk (with brackets) so that the center of the spindle hole is no more than 1 micrometer from the center of gravity of the disk, done by shaving the disk,

10. Removing the disk from the test spindle, placing it into a vacuum chamber, heating and re-polishing it to remove adsorbed gasses,

11. Cooling the disk by liquid argon, and reapplying the vacuum. (argon is used because it is not adsorbed),

12. Vaporizing and depositing a metal (rare earth and cobalt, the exact composition of which forms no part of this invention) as an amorphous film on the disk (the extreme cold of the silicon disk causes the metallic film to solidify before any crystals can form),

13. Polishing this film in a vacuum, and

14. Re-mounting the disk on the test spindle and re-balancing as above, using the same brackets and screws in the same locations.

Performance Comparison with Current Technology

Although it might appear that the massively parallel architecture of the disk drive would benefit sequential transfer much more than random access, this is not so, as demonstrated by the following examples:

### EXAMPLE 1

### Random Access Times

Table 2 compares the worst-case performance of a disk drive based on current technology (Old Drive) with the disk drive of this invention (New Drive). These assumptions are made:

1. Each disk drive has a single functional side. (More sides would not change the relative results.)

2. All disk operations are independent, addressing 1 block each, chosen at random.

3. Head acceleration is instantaneous. (This gives the benefit of the doubt to current technology.)

4. Rotation Rate=100 revolutions per second for both.

5. Old drive:

Average Latency Time=10,000 μs/2=5 ms

Average Seek Time=10,000 μs (number of tracks to move)

Use of overlapped seeks by controller or operating system

6. New Drive:

Total Latency Time=10,000 μs=10 ms

Total Seek Time=0

Use of overlapped seeks (automatic)

The term “overlapped seeks” refers to the method of reducing total access time (hence, also average access time) by sorting all operations to be performed in order of disk address, and then executing the operations in the sorted order. This permits the drive to handle all of the operations in a single sweep of the moving head from one end of its orbit to the other.

TABLE 2

| | | | | | | New: | | New: |
|---|---|---|---|---|---|---|---|---|
| | Old: | Old: | | Old: | New: | Sum of | New: | Average |
| Blocks | Sum of | Sum of | Old: | Average | Sum of | Seek | Total | Time μs |
| to | Latency | Seek | Total | Time μs | Latency | Time | Time | per |
| Process | Time μs | Time μs | Time μs | per block | Time μs | μs | μs | block |
| 1 | 5,000 | 10,000 | 15,000 | 15,000 | 10,000 | 0 | 10,000 | 10,000 |
| 10 | 50,000 | 10,000 | 60,000 | 6,000 | 10,000 | 0 | 10,000 | 1,000 |
| 100 | 500,000 | 10,000 | 510,000 | 5,100 | 10,000 | 0 | 10,000 | 100 |
| 1,000 | 5,000,000 | 10,000 | 5,010,000 | 5,010 | 10,000 | 0 | 10,000 | 10 |
| 10,000 | 50,000,000 | 10,000 | 50,010,000 | 5,001 | 10,000 | 0 | 10,000 | 1 |

The rows referring to 1,000 and 10,000 blocks are typical for very large multi-user systems. The row referring to 10 blocks is typical for small single-user systems.

It is observed that, even in the case of 10 operations, the New Drive system is 6 times faster than an Old Drive system, while in the case of 10,000 operations (common on large multi-user systems), it is 5,010 times faster than an Old Drive system using current technology.

### EXAMPLE 2

### Sequential Access Times

Table 3 compares the worst case performance of an Old Drive with the New Drive. Assumptions made are:

1. Each disk drive has a single functional side.

2. All operations address a single group of blocks, in sequential order.

3. Head acceleration is instantaneous. (giving the benefit of doubt to current technology.)

4. Rotation Rate=100 revolutions per second for both.

5. Old drive:

Average Latency Time per block=10,000/4,096 μs =2.44140625 μs just enough time to read a single block; it is assumed that the latency time for the first block is zero: that is the first block is ready to process.)

Average Seek Time to change tracks=10,000/(32,768) μs=0.30517578125 μs just enough time to switch from one track to the next; it is assumed that the seek time for the first block is zero: the first block is ready to process.)

Use of overlapped seeks is irrelevant.

6. New Drive:

TABLE 3
Total Latency Time = 10,000 μs = 10 ms
Total Seek Time = 0
Use of overlapped seeks is irrelevant.

| | | Old: | | Old: | | | | |
|---|---|---|---|---|---|---|---|---|
| | | Sum | | Avg. | | New: | | New: |
| | Old: | of | | Time | New: | Sum of | | Average |
| Blocks | Sum of | Seek | Old: | μs | Sum of | Seek | New: | Time μs |
| to | Latency | Time | Total | per | Latency | Time | Total | per |
| Process | Time μs | μS | Time μs | block | Time μs | μs | Time μs | block |
| 1 | 2.44 | 0 | 2 | 2 | 2.44 | 0 | 2.44 | 2 |
| 10 | 24 | 0 | 24 | 2 | 24 | 0 | 24 | 2 |
| 100 | 244 | 0 | 244 | 2 | 244 | 0 | 244 | 2 |
| 1,000 | 2,440 | 0 | 2,440 | 2 | 2,440 | 0 | 2,440 | 2 |
| 10,000 | 24,400 | 0.61 | 24,401 | 2 | 10,000 | 0 | 10,000 | 1.00 |
| 100,000 | 244,000 | 6.1 | 244,006 | 2 | 10,000 | 0 | 10,000 | 0.10 |
| 1,000,000 | 2,440,000 | 61 | 2,440,061 | 2 | 10,000 | 0 | 10,000 | 0.010 |
| 10,000,000 | 24,400,000 | 610 | 24,400,610 | 2 | 10,000 | 0 | 10,000 | 0.0010 |

The row referring to 1,000,000 blocks is typical of most cases of large sequential reads for very large multi-user systems. The row referring to 100 blocks is typical for small single-user systems.

It is observed that, in the case of 10,000 operations, the New Drive is 2 times faster than the Old Drive using current technology. In the case of 100,000 operations, it is 20 times faster. In the case of 1,000,000 operations, it is 200 times faster, and in the case of 10,000,000 operations, it is 2,000 times faster. Millions of operations are common in full table scans of large tables by relational database engines.

Interaction with Host Computer

As noted above, the detailed design of disk controller 81 depends on the architecture of the host computer. In particular, the extremely high transfer speeds of the system of this invention requires the fastest possible connection to the host computer to utilize the speed of the disk drive system. The following are the most important requirements of the relationship of the disk drive to the host.

1. The host computer must have the widest possible memory bus. Today, in the fastest computers, such busses are typically 256 bits wide. Common 32-bit busses, such as found in personal computers, are totally inadequate. In general, it is best for the block size of the disk drive to be exactly equal to the memory block size of the host computer. This eliminates the need to assemble and disassemble blocks for transfer in each direction.

2. The Disk Controller must have its own dedicated connection (port) to RAM.

3. RAM should have interleaved addressing: block 0 in memory module 0, block 1 in module 1, . . . block 15 in module 15, block 16 in module 0, block 17 in module 1, . . . etc. This permits multiple memory operations to occur simultaneously.

4. A proper disk driver program to operate the controller must be very carefully written.

These requirements are necessary to achieve the full potential of the disk drive of this invention. Without them, performance improvements of a factor of only 100 or even as little as 10 over current technology may occur.

There are several other aspects of this invention. Because the circumference of the tracks increases with the distance from the center of the disk, it is possible to store more data per track on the outer tracks than on the inner ones. It is wasteful to use the same number of sectors for all tracks on a large disk. Instead, it is possible to use a zoned disk 120, as shown in FIG. 14. Rather than the use of a single magnetic head assembly for each side of a disk, several head assemblies are mounted, each more distant from the center than the previous one. If the disk diameter is 256 mm, excluding 5 mm outer margin, the disk can be divided into zones as follows.

A central inner zone 122 is unused. Progressing radially outwardly are a first zone 124, a second zone 126 and a third zone 128. Each zone is serviced by its own fixed magnetic head assembly and controller. Because it contains twice the area of zone 124, zone 126 can contain twice as much data. Similarly, zone 128 can contain three times as much data as zone 124. Zones 124, 126 and 128 are serviced by magnetic head assemblies 130, 132 and 134, respectively. Clearly, more than three zones and three head assemblies can be used.

To promote cooling and reduce turbulence, the disk casing can be filled with hydrogen or helium gas. Because of their low molecular weights, either of these gases will improve heat transfer between the magnetic head assembly and the disk casing. In addition, because of the much higher speed of sound and lower viscosity of these gases, the Mach and Reynolds numbers are reduced for a given rotation speed, which reduces turbulence and permits higher speeds of rotation.

Operation in Vacuuo

Alternatively, the chamber containing the disk can be evacuated to extremely low pressures. This eliminates all turbulence and permits higher speeds of rotation. In this case, the magnetic head assembly must be cooled by either water/glycol mixture or by an organic refrigerant which flows between the back side of the silicon wafer and the housing. The cooling fluid flows to and from the head assembly via a pair of flexible plastic tubes (not shown).

Alternative Optical Storage Embodiment

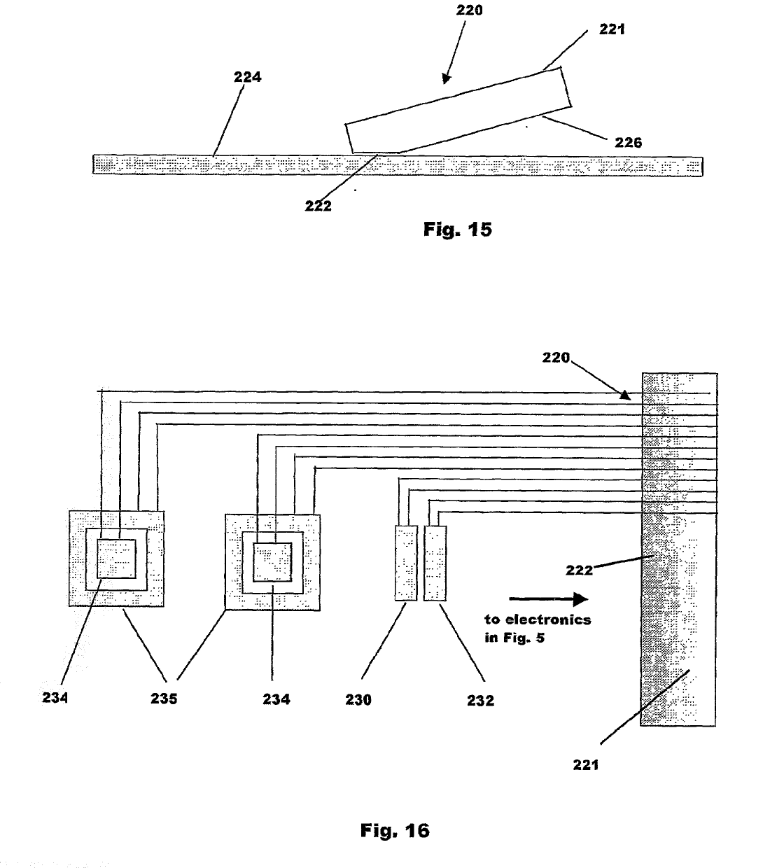

Instead of using magnetic heads as described above, an alternative approach is to substitute light-emitting diodes and photo-transistors in order to read and write an optical medium that is substituted for the magnetic medium. This embodiment is shown in FIGS. 15 and 16, where items corresponding to items in the previously described embodiment bear the same numbers increased by 200. Thus, an optical head 220 comprises a silicon wafer 221, which has an optical surface 227 for recording data. This surface is composed of an extremely thin film of polycarbonate plastic impregnated with a specially chosen organic dye. The dye has three quantum states which are relevant here:

1. G: The ground state.

2. A: A metastable activated state, whose energy difference from the ground state corresponds to a photon of a particular wavelength W, the writing wavelength.

3. U: An unstable state, which emits a photon and promptly decays to the ground state, whose energy difference from the ground state corresponds to a photon of a particular wavelength E, the erasing wavelength.

When in state G the color of the dye is distinct from the color in state A. This color difference is read by means of a third wavelength of light R, the reading wavelength.

Instead of using three magnetic heads, this embodiment uses three light-emitting diodes 230, 232 and 234, of colors W, E, and R, which write, erase and read the data, respectively. In addition, there is a photo-transistor 235 which detects the reflection of light of the reading wavelength, and is insensitive to other wavelengths because of an interference filter applied thereto.

The operation cycle is as follows: Information in a block is erased using wavelength E. Next, data are written using wavelength W. These data are immediately re-read using wavelength R for validation, whose reflection is picked up by the photo-transistor detector. In order to read the data, the reading function takes place without the writing function.

Expect for the use of a photochemical medium on the disk, rather than a magnetic medium, the design is the same as described previously.

Insertion Sorting Algorithm

In this example, only 10 sectors (instead of 4096) are used for clarity and brevity. Rows shown in bold and italicized are shifted down.

If the current sector is 7 and the sector to be inserted is 8:

| Row | Sector | Insert at | (S-I) mod 10 | (S-I) mod 10-R |
|---|---|---|---|---|
| 0 | 7 | 8 | 8 | +8 |
| 1 | 8 | 8 | 9 | +8 |
| 2 | 9 | 8 | 0 | −2 |
| 3 | 0 | 8 | 1 | −2 |
| 4 | 1 | 8 | 2 | −2 |
| 5 | 2 | 8 | 3 | −2 |
| 6 | 3 | 8 | 4 | −2 |
| 7 | 4 | 8 | 5 | −2 |
| 8 | 5 | 8 | 6 | −2 |
| 9 | 6 | 8 | 7 | −2 |

If the current sector is 7 and the sector to be inserted is 2:

| Row | Sector | Insert at | (S-I) mod 10 | (S-I) mod 10-R |
|---|---|---|---|---|
| 0 | 7 | 2 | 4 | +4 |
| 1 | 8 | 2 | 5 | +4 |
| 2 | 9 | 2 | 6 | +4 |
| 3 | 0 | 2 | 7 | +4 |
| 4 | 1 | 2 | 8 | +4 |
| 5 | 2 | 2 | 9 | +4 |
| 6 | 3 | 2 | 0 | −6 |
| 7 | 4 | 2 | 1 | −6 |
| 8 | 5 | 2 | 2 | −6 |
| 9 | 6 | 2 | 3 | −6 |

If the current sector is 7 and the sector to be inserted is 0:

| Row | Sector | Insert at | (S-I) mod 10 | (S-I) mod 10-R |
|---|---|---|---|---|
| 0 | 7 | 0 | 6 | +6 |
| 1 | 8 | 0 | 7 | +6 |
| 2 | 9 | 0 | 8 | +6 |
| 3 | 0 | 0 | 9 | +6 |
| 4 | 1 | 0 | 0 | −4 |
| 5 | 2 | 0 | 1 | −4 |
| 6 | 3 | 0 | 2 | −4 |
| 7 | 4 | 0 | 3 | −4 |
| 8 | 5 | 0 | 4 | −4 |
| 9 | 6 | 0 | 5 | −4 |

If the current sector is 5 and the sector to be inserted is 7:

| Row | Sector | Insert at | (S-I) mod 10 | (S-I) mod 10-R |
|---|---|---|---|---|
| 0 | 5 | 7 | 7 | +7 |
| 1 | 6 | 7 | 8 | +7 |
| 2 | 7 | 7 | 9 | +7 |
| 3 | 8 | 7 | 0 | −3 |
| 4 | 9 | 7 | 1 | −3 |
| 5 | 0 | 7 | 2 | −3 |
| 6 | 1 | 7 | 3 | −3 |
| 7 | 2 | 7 | 4 | −3 |
| 8 | 3 | 7 | 5 | −3 |
| 9 | 4 | 7 | 6 | −3 |

While only a preferred and alternative embodiment of this invention have been own and described, modifications will become readily apparent and are intended be covered by the appended claims.

I claim:

1. A computer disk drive having a driven disk and a head assembly comprising at least one read/write head associated with the disk, wherein both heads and disk are fabricated of crystalline silicon.

2. The computer disk drive of claim 1, wherein the disk is coated with an amorphous layer of neodymium and cobalt.

3. The computer disk drive of claim 1, wherein the head assembly is mounted on a single silicon wafer.

4. The computer disk drive of claim 3, wherein a head assembly is provided for each side of a disk.

5. The computer disk drive of claim 3, wherein the disk is divided into two or more circular zones, and a separate head assembly is provided for each zone.

6. The computer disk drive of claim 3, wherein the disk drive has read and write electronics that are mounted on the same silicon wafer which mounts the magnetic heads.

7. The computer disk drive of claim 6, wherein the silicon wafer includes a beveled edge mounting the heads, and the read and write electronics are mounted elsewhere on the silicon wafer in a position removed from the vicinity of the disk.

8. The computer disk drive of claim 3, including proximity sensors to sense the spacing of the head on the wafer relative to the disk, and piezoelectric actuators directed by the proximity sensors to precisely control said spacing.

9. A computer disk drive comprising a driven disk having a plurality of data storage tracks, and a disk assembly comprising at least one fixed read/write/verify head associated with the disk, wherein the head assembly processes all tracks concurrently, thus enabling all tracks to be processed during a single revolution of the disk.

10. The computer disk drive of claim 9, wherein the head assembly includes a disk controller having means for performing repeated data insertions to maintain the proper order of pending operations.

11. The computer disk drive of claim 10, wherein the disk controller includes means to move entire blocks of data simultaneously to/from the head assembly.

12. The computer disk drive of claim 8, wherein the disk controller contains data buffers, and including a data transfer module for transferring data between the data buffers, and an operation sequence module connected to a host computer for accepting, sorting and completing requests instructed by said computer, wherein both modules operate concurrently and semi-independently.

13. In a disk rotor drive assembly that includes a spindle and a data disk mounted thereon for rotation therewith relative to a support, the improvement comprising a magnetic bearing having a rotor member mounted on the spindle for rotation therewith and a stator member mounted on the support, wherein one of said members has a plurality of identical sets of permanent magnets in a circumferential array, each set comprising four different magnets arranged, sequentially counterclockwise, with north poles respectively pointed inward, counterclockwise, outward and clockwise, such that rotation of the rotor induces magnetic fields in the reactance loops that cooperate with the magnetic fields of the permanent magnets to suspend the rotor relative to the stator for substantially frictionless relative rotation.

14. The improvement of claim 13, including reactance loops spaced axially above and beneath the rotor.

15. The improvement of claim 14, wherein said one member is the rotor and the other said member is the stator.

16. The improvement of claim 13, including a pair of said magnetic bearings, each of which is oppositely axially spaced from the disk to support both ends of the spindle.

17. The improvement of claim 14, including a mechanical bearing mounting the spindle for initial rotation and including inner and outer race members, said members being separated to disengage the mechanical bearing races when said magnetic bearing becomes effective to support said spindle.

18. The disk drive assembly of claim 1, wherein the disk is mounted on a spindle for rotation therewith relative to a support and including a magnetic bearing having a rotor member mounted on the spindle for rotation therewith and a stator member mounted on the support, wherein one of said members have a plurality of identical sets of permanent magnets in a circumferential array, each set comprising four different magnets arranged, sequentially counterclockwise, with north poles respectively pointed inward, counterclockwise, outward and clockwise, plurality of identical sets of permanent magnets in a circumferential array, such that rotation of the rotor induces magnetic fields in the reactance loops that cooperate with the magnetic fields of the permanent magnets to suspend the rotor relative the stator for substantially frictionless relative rotation, wherein said disk drive assembly is encapsulated within an enclosure that is subjected to a vacuum, thereby enabling use of extremely high disk rotation speeds without turbulence and consequent vibration.

19. The computer disk drive of claim 1, wherein the disk is coated with bistable organic dyes and the head includes photo-transistors to read and verify data and LEDs for writing and erasing data on the disk.

20. A method of operating a computer disk drive which utilizes the apparatus of any of claims 1-12, thereby enabling both sequential and random data access time improvements over prior art technologies of by a factor of at least 2000.
